(19) United States
(12) Patent Application Publication
(10) Pub. No.: US 2003/0012024 A1
(43) Pub. Date: Jan. 16, 2003

(54) NECKLESS DECORATIVE SHELL FOR LIGHT STRING

(76) Inventor: Chin-Weih Wu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/904,523

(22) Filed: Jul. 16, 2001

(51) Int. Cl. F21V 15/00

(52) U.S. Cl. 362/362; 362/354; 362/437; 362/363

(57) ABSTRACT

The present invention relates to a decorative shell of a bulb assembly of a light string. The decorative shell is provided with an inward extended connecting portion to engage with a bulb holder of a bulb assembly that keeps a complete original pattern of the decorative shell. A bulb of the bulb assembly can be inserted into inner space of the shell and near to front surface of the shell to increase lighting degree and decorative effect.

### BACKGROUND OF THE INVENTION

It is known that a light string includes many bulb assemblies on a main electrical wire. Each bulb assembly has a bulb (21), which is received in a bulb holder (2). A conventional decorative shell (1) is provided with an outward extended connecting portion (11), as shown in FIG. 1, to engage with the bulb holder (2) while the bulb (21) can insert into inner space of the shell (1). Since the connecting portion (11) is outward extended, it destroys an original pattern of the shell (1) and decorative effect of the shell (1) would be reduced. Moreover, this known structure provides week lighting effect due to the bulb (21) being placed at a bottom position of the shell (1).

Accordingly, the primary object of the invention is to provide a decorative shell of a bulb assembly of a light string, which provides a decorative shell having an original pattern to display a better decoration and increases lighting effect of the shell. Now the features and advantages of the present invention will be described in detail with reference to the accompanying drawings.

### BRIEF DESCRIPTION OF ACCOMPANYING DRAWINGS

FIG. 1 is a cross-sectional plan view showing a prior decorative shell with a bulb assembly.

FIG. 2 is a cross-sectional plan view showing a decorative shell with a bulb assembly according to the present invention.

FIG. 3 is a perspective view showing a decorative shell with a bulb assembly according to the present invention.

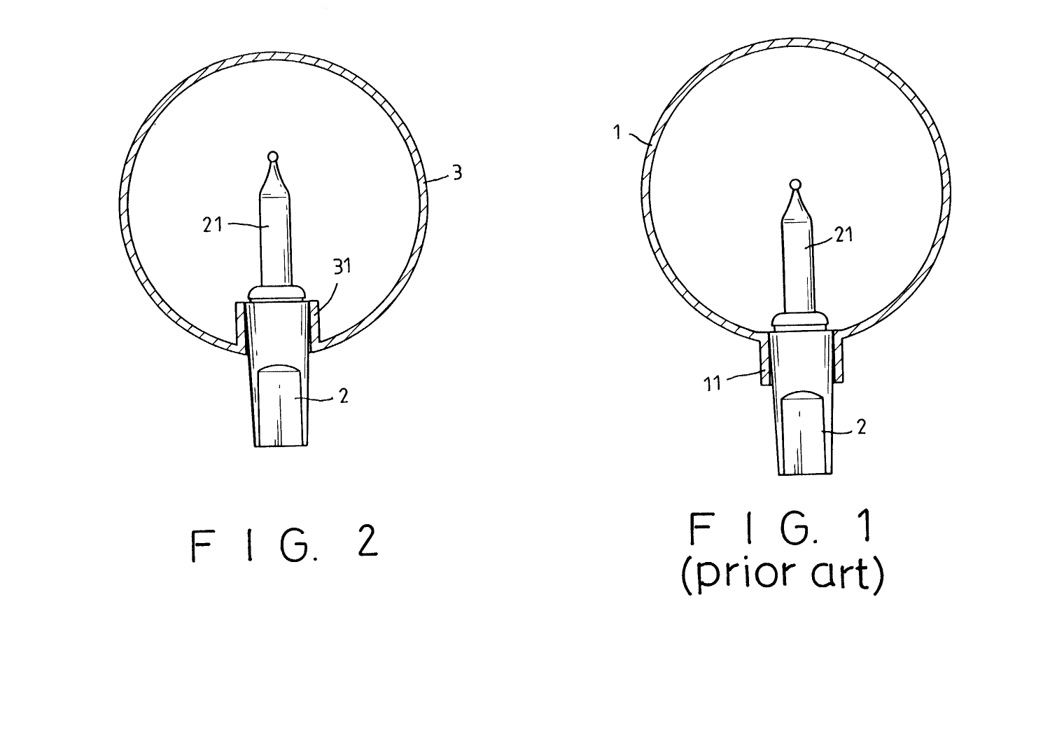

### DETAILED DESCRIPTION OF PREFERRED EMBODIMENTS

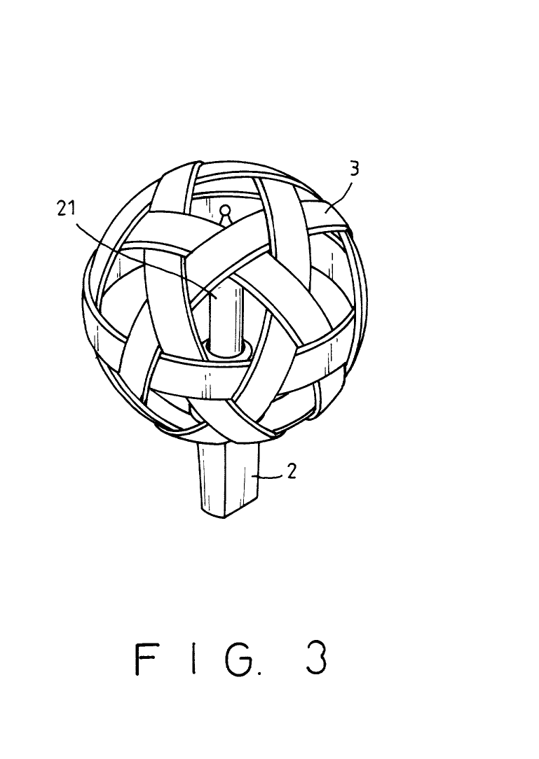

Please refer to FIGS. 2 and 3, the present invention relates to an improvement of a decorative shell (3) of a bulb assembly of a light string. The decorative shell (3) of this invention is provided with an inward extended connecting portion (31) for engaging with a bulb holder (2) while the bulb (21) extends inside the shell (3). Since the connecting portion (31) is inward extended, the outlook of the decorative shell (3) may keep its original pattern as designed that obtains a beautiful complete decoration. Furthermore, the connection according to the present invention leads the bulb (21) more near to front surface of the shell (3). So the light of the bulb (21) can emit outside with a better lighting degree to increase decorative effect.

Accordingly, the present invention provides an invented design of a decorative shell of a bulb assembly of a light string, which provides a complete original pattern of the decorative shell and increases lighting degree of the decoration. It obviously gains the utility and novelty for patent and is thus applied.

What is claimed is:

1. A decorative shell of a bulb assembly of a light string including a decorative shell provided with an inward extended connecting portion to engage with a bulb holder of a bulb assembly while a bulb of the bulb assembly is inserted into inner space of the shell and near to front surface of the shell.
